(19) United States
(12) Patent Application Publication
(10) Pub. No.: US 2026/0099673 A1
(43) Pub. Date: Apr. 9, 2026

(54) MEMORY-EFFICIENT DRAFT MACHINE LEARNING MODEL

(71) Applicant: QUALCOMM Incorporated, San Diego, CA (US)

(72) Inventors: Mingu LEE, San Diego, CA (US); Wonseok JEON, San Diego, CA (US); Junyoung PARK, Palo Alto, CA (US); Kanghoon YOON, San Diego, CA (US); Christopher LOTT, San Diego, CA (US)

(21) Appl. No.: 19/051,081

(22) Filed: Feb. 11, 2025

Related U.S. Application Data
(60) Provisional application No. 63/704,986, filed on Oct. 8, 2024.

(51) Int. Cl. G06F 40/284; G06F 40/40; G06N 3/0455

(52) U.S. Cl. CPC G06F 40/284; G06F 40/40; G06N 3/0455

(57) ABSTRACT

Disclosed are systems, apparatuses, processes, and computer-readable media for model training. A device may process, using a linear layer, an embedding generated from a first output token and input features to generate first features, wherein the first output token is generated by a previous iteration of a token predictor and wherein the input features are generated by a previous iteration of a decoding layer. A device may process, using the decoding layer, the first features to generate second features having first dimensions. A device may process, using a down-projection layer, the second features to generate third features having second dimensions smaller than the first dimensions. A device may generate, using the token predictor and the third features, a second output token.

### CROSS-REFERENCE TO RELATED APPLICATIONS

The present application claims the benefit of U.S. Provisional Application No. 63/704,986, filed on Oct. 8, 2024, which is herein incorporated by reference in its entirety for all purposes.

### FIELD

The present disclosure generally relates to machine learning models. For example, aspects of the present disclosure include a memory-efficient draft machine learning model, which can provide improved speculative decoding used in machine learning models (e.g., transformer-based models such as Large Language Models (LLMs)).

### BACKGROUND

Many devices and systems can obtain data (e.g., text) and can process the data to perform one or more functions, such as providing answers to user questions, outputting information for a display, outputting information for further processing and/or consumption by other devices, among other uses.

Data processing may be performed by neural networks. A neural network attempts to replicate, using computer technology, logical reasoning performed by the biological neural networks that constitute animal brains. For example, Large Language Models (LLMs) can predict output text from input text and are used in many applications.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for improved speculative decoding for machine learning models. In some aspects, a method of using a machine learning model to generate tokens is provided. The method includes: processing, using a linear layer, an embedding generated from a first output token and input features to generate first features, wherein the first output token is generated by a previous iteration of a token predictor and wherein the input features are generated by a previous iteration of a decoding layer; processing, using the decoding layer, the first features to generate second features having first dimensions; processing, using a down-projection layer, the second features to generate third features having second dimensions smaller than the first dimensions; and generating, using the token predictor and the third features, a second output token.

In some aspects, an apparatus for using a machine learning model to generate tokens is provided. The apparatus includes at least one memory and at least one processor coupled to the at least one memory and configured to: process, using a linear layer, an embedding generated from a first output token and input features to generate first features, wherein the first output token is generated by a previous iteration of a token predictor and wherein the input features are generated by a previous iteration of a decoding layer; process, using the decoding layer, the first features to generate second features having first dimensions; process, using a down-projection layer, the second features to generate third features having second dimensions smaller than the first dimensions; and generate, using the token predictor and the third features, a second output token.

In some aspects, a non-transitory computer-readable medium is provided having stored thereon instructions that, when executed by at least one processor, cause the at least one processor to: process, using a linear layer, an embedding generated from a first output token and input features to generate first features, wherein the first output token is generated by a previous iteration of a token predictor and wherein the input features are generated by a previous iteration of a decoding layer; process, using the decoding layer, the first features to generate second features having first dimensions; process, using a down-projection layer, the second features to generate third features having second dimensions smaller than the first dimensions; and generate, using the token predictor and the third features, a second output token.

In some aspects, an apparatus for using a machine learning model to generate tokens is provided. The apparatus includes: means for processing, using a linear layer, an embedding generated from a first output token and input features to generate first features, wherein the first output token is generated by a previous iteration of a token predictor and wherein the input features are generated by a previous iteration of a decoding layer; means for processing, using the decoding layer, the first features to generate second features having first dimensions; means for processing, using a down-projection layer, the second features to generate third features having second dimensions smaller than the first dimensions; and means for generating, using the token predictor and the third features, a second output token.

In some aspects, a method of using a machine learning model to generate tokens is provided. The method including: processing, using a down-projection layer, input features to generate first features; processing, using a linear layer, the first features, an embedding generated from a first output token, and an additional feature to generate second features, wherein the first output token is generated by a previous iteration of a token predictor and wherein the additional feature is generated by a previous iteration of a decoding layer; processing, using the decoding layer, the second features to generate third features; and processing, using the token predictor, the third features to generate a second output token.

In some aspects, an apparatus for using a machine learning model to generate tokens is provided. The apparatus includes at least one memory and at least one processor coupled to the at least one memory and configured to: process, using a down-projection layer, input features to generate first features; process, using a linear layer, the first features, an embedding generated from a first output token, and an additional feature to generate second features, wherein the first output token is generated by a previous iteration of a token predictor and wherein the additional feature is generated by a previous iteration of a decoding layer; process, using the decoding layer, the second features to generate third features; and process, using the token predictor, the third features to generate a second output token.

In some aspects, a non-transitory computer-readable medium is provided having stored thereon instructions that, when executed by at least one processor, cause the at least one processor to: process, using a down-projection layer, input features to generate first features; process, using a linear layer, the first features, an embedding generated from a first output token, and an additional feature to generate second features, wherein the first output token is generated by a previous iteration of a token predictor and wherein the additional feature is generated by a previous iteration of a decoding layer; process, using the decoding layer, the second features to generate third features; and process, using the token predictor, the third features to generate a second output token.

In some aspects, an apparatus for using a machine learning model to generate tokens is provided. The apparatus includes: means for processing, using a down-projection layer, input features to generate first features; means for processing, using a linear layer, the first features, an embedding generated from a first output token, and an additional feature to generate second features, wherein the first output token is generated by a previous iteration of a token predictor and wherein the additional feature is generated by a previous iteration of a decoding layer; means for processing, using the decoding layer, the second features to generate third features; and means for processing, using the token predictor, the third features to generate a second output token.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example system, in accordance with some aspects of the disclosure.

FIG. 2 is a diagram illustrating a system for speculative decoding, in accordance with some aspects of the disclosure.

FIG. 3 is a diagram illustrating a system for speculative decoding, in accordance with some aspects of the disclosure.

FIG. 4 is a diagram illustrating a first flow for training a system for speculative decoding, in accordance with some aspects of the disclosure.

FIG. 5 is a diagram illustrating a first flow for using a system for speculative decoding, in accordance with some aspects of the disclosure.

FIG. 6 is a diagram illustrating a second flow for training a system for speculative decoding, in accordance with some aspects of the disclosure.

FIG. 7 is a diagram illustrating a second flow for using system for speculative decoding, in accordance with some aspects of the disclosure.

FIG. 8 is a flow diagram illustrating another example of flow for speculative decoding, in accordance with some aspects of the disclosure.

FIG. 9 is a flow diagram illustrating another example of flow for speculative decoding, in accordance with some aspects of the disclosure.

FIG. 10 is a diagram illustrating an example of a system for implementing certain aspects described herein.

FIG. 11 is a block diagram illustrating an example of a deep learning network, in accordance with some aspects of the disclosure.

FIG. 12 is a block diagram illustrating an example of a convolutional neural network, in accordance with some aspects of the disclosure.

FIG. 13 is a block diagram of an example transformer, in accordance with some aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Aspects described herein relate to use of Machine Learning (ML) models. Machine learning in general can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of an ML system, and can include an input layer, one or more hidden layers, and an output layer. Data is provided from input nodes of the input layer, processing is performed by hidden nodes of the one or more hidden layers, and an output is produced through output nodes of the output layer. DL networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A DL architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Certain aspects involve transformer neural networks (“transformers”, also referred to as transformer-based models, systems, or networks). In a convolutional neural network (CNN) model, the number of operations required to relate signals from two arbitrary input or output positions grows in the distance between positions, which makes learning dependencies at different distant positions challenging for a CNN model. A transformer reduces the operations of learning dependencies by using an encoder and a decoder that implement an attention mechanism at different positions of a single sequence to compute a representation of that sequence.

Certain aspects of the disclosure relate to improvements in machine learning systems, such as transformer-based models. Large Language Models (LLMs) are an example of transformer-based models. LLMs use a combination of techniques in deep learning and natural language processing. An “inference” with respect to an LLM (or other model) refers to a LLM's ability to draw conclusions based on prior knowledge or context clues.

Speculative decoding can improve the performance of LLM inferences by leveraging parallel processing. However, as described in more detail below, speculative decoding may require a large amount of memory consumption, resulting in a memory-bound limit on performance. Such a problem is particularly acute when an LLM is deployed on a memory-constrained device, such as a mobile or portable device. For example, because an LLM generates only one token per inference due to autoregressive properties of LLMs, all model parameters are loaded into memory for generating each token. Even on devices that do not have memory constraints (e.g., server computers or other devices with large amounts of memory capacity), the autoregressive nature of LLMs may result in memory bandwidth of such devices becoming a bottleneck for improving system performance.

Systems, apparatuses, electronic devices, methods (also referred to as processes), and computer-readable media (collectively referred to herein as “systems and techniques”) are described herein provide a memory-efficient draft machine learning (ML) model. For example, the draft ML model can be used to predict a feature of a target LLM, which can then be used by the target LLM to predict tokens. In some aspects, the systems and techniques can reduce a size (e.g., feature dimension) of a Language Model (LM) head of the draft ML model by applying merged projection layers and/or reducing a size of an auto regression component of the draft ML model. The systems and techniques can provide improved speculative decoding used in machine learning models (e.g., transformer-based models such as LLMs), resulting in reduced memory consumption in speculative decoding.

Various aspects of the application will be described herein with respect to the figures.

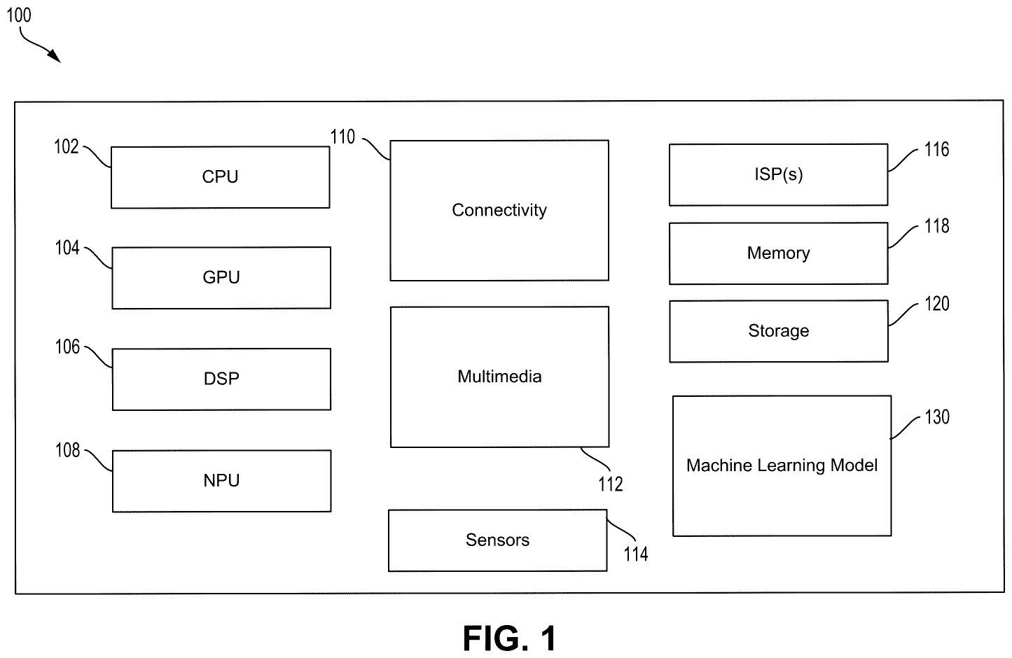

FIG. 1 illustrates an example implementation of a system-on-a-chip (SOC) 100, which may include a central processing unit (CPU) 102 or a multi-core CPU, configured to perform one or more of the functions described herein. For instance, SOC 100 may use one or more machine learning models 130 (e.g., transformer-based models, such as LLMs) to perform different functions such as textual prediction. SOC 100 may also perform the improved approaches to speculative decoding of machine learning models 130 (e.g., transformer-based models, such as LLMs), as discussed herein. For instance, model 130 may be improved to increase performance and/or reduce memory consumption using the techniques described herein. Example applications using model 130 include, but are not limited to, processing text queries to generate output answers to the text queries.

SOC 100 can include one or more processors such as central processing unit (CPU) 102, graphics processing unit (GPU 104), a digital signal processor (DSP) 106, neural processing unit (NPU) 108, and one or more image signal processors (ISPs) 116. Parameters or variables (e.g., neural signals and synaptic weights), system parameters associated with a computational device (e.g., neural network with weights), delays, frequency bin information, task information, among other information may be stored in a memory block associated with a NPU 108, in a memory block associated with a CPU 102, in a memory block associated with a GPU 104, in a memory block associated with DSP 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include one or more sensors 114 and/or storage 120.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

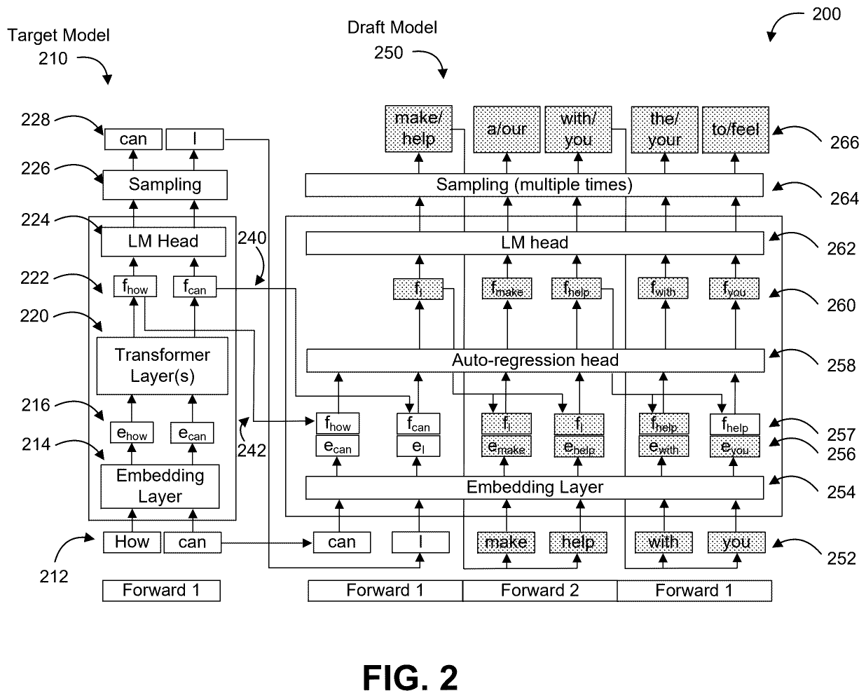

FIG. 2 is a diagram illustrating a system 200 for speculative decoding, in accordance with some aspects of the disclosure. The system 200 includes a target LLM 210 and a draft LLM 250. According to various aspects described herein, the draft LLM 250 operates to improve the performance and lower the memory consumption of the target LLM 210 by learning to predict features of the target LLM 210.

For example, performance can be increased due to the draft LLM 250 being smaller than the target LLM 210 and therefore requiring less memory to execute than the draft LLM 250. For example, the draft LLM 250 may execute inference multiple times, resulting in multiple tokens. In turn, the multiple tokens can be provided to the target LLM 210, which need only run inference once to process the multiple tokens and any input tokens associated with an input query to generate multiple predicted tokens, resulting in a performance improvement. In some examples, the draft LLM 250 can execute inference four times and the target LLM 250 can execute inference once to generate multiple predicted tokens. Such a process can repeat as necessary to generate a desired output (e.g., to provide a text answer to the input query). Other examples are possible.

The target LLM 210 and the draft LLM 250 may have certain layers that are similar or identical and may have other layers that are different. For example, from an architectural standpoint, an embedding layer 214 and a Language Model (LM) head 224 of the target LLM 210 may be the same or similar to an embedding layer 254 and an LM head 262 of the draft LLM 250, while the transformer layers 220 of the target LLM 210 may be different than the auto-regression head 258 of the draft LLM 250. For instance, the transformer layers 220 may have a different number of transformer layers and/or parameters, such as weights, as compared to the regression head 258.

The embedding layer 254, auto-regression head 258, and LM head 262 of the draft LLM 250 can work together to improve performance of the target LLM 210. As shown, the target LLM 210 and the draft LLM 250 are interconnected by pathways 240 and 242, which provide copies of various features 222 (denoted as f_{how} and f_{can} as illustrative examples) that are output from transformer layers 220 of the target LLM 210 to inputs of the auto-regression head 258 of the draft LLM 250. The draft LLM 250 can obtain (e.g., from memory, from transformer layers 220, etc.) the features 222 of the target LLM 210 and process the features using auto-regression head 258 during inference, as shown below:

$${f}_{i + 1} = AutoRegressionHad ( {f}_{i} , {e}_{i + 1} )$$

The system 200 may be trained using a regression loss (L_{reg}) and a next token prediction loss (Lₑₗₛ), such as using the below loss functions:

$${L}_{reg} = SmoothL 1 ( {f}_{i + 1} , AutoRegHead ( {e}_{2 : i + 1} , {f}_{1 : i} ) )$$

$${L}_{cls} = CE ( {p}_{i + 1} , Softmax ( LM HEAD ( \hat{f} ) ) )$$

$${L}_{final} = {L}_{reg} + {wL}_{cls} ,$$

where a final loss (L_{final}) is a combination (e.g., sum) of the regression loss (L_{reg}) and next token prediction loss (Lₑₗₛ).

The target LLM 210 can receive tokens 212 and can process the tokens 212 using the embedding layer 214 to generate embeddings 216 representing the tokens 212. For instance, the embeddings 216 can represent the tokens in a numerical space (e.g., using a vector or a matrix representation). The embeddings 216 can then be provided to transformer layer(s) 220. The transformer layer(s) 220 can process the embeddings 216 to generate features 222. As noted previously, the features 222 can be output, via pathways 240 and 242, to the draft LLM 250 for processing by the auto-regression head 258. The features 222 can also be processed by the LM head 224 of the target LLM 210 to generate an output that is sampled by a sampling stage 226. The sampling stage 226 can output predicted tokens 228.

The draft LLM 250 can receive token(s) 252 and can process the token(s) 252 using embedding layer 254 to generate one or more embeddings 256. The embedding(s) 256 represent the tokens in a numerical space (e.g., using a vector or a matrix). The embedding(s) 256 can be combined (e.g., concatenated) with corresponding features 257 from the target LLM 210 (e.g., output from the transformer layers 220). The combined embeddings 256 and features 257 can be provided to the auto-regression head 258. The auto-regression head 258 can process the combined embeddings 256 and features 257 to generate one or more features 260. In some aspects, the auto regression head 258 can include a linear layer (e.g., a fully connected layer) and decoder layer. The features 260 from the auto regression head 258 can be provided to the LM head 262. The LM head 262 can process the features 260 to generate an output, which can be processed by a sampling layer 264. The sampling layer 264 can generate one or more predicted tokens 266 for output. As noted above, the draft LLM 250 can run in an auto-regressive manner, generating one token per iteration (e.g., per inference) of the draft LLM 250. The predicted tokens 266 can then be provided as input to the target LLM 210.

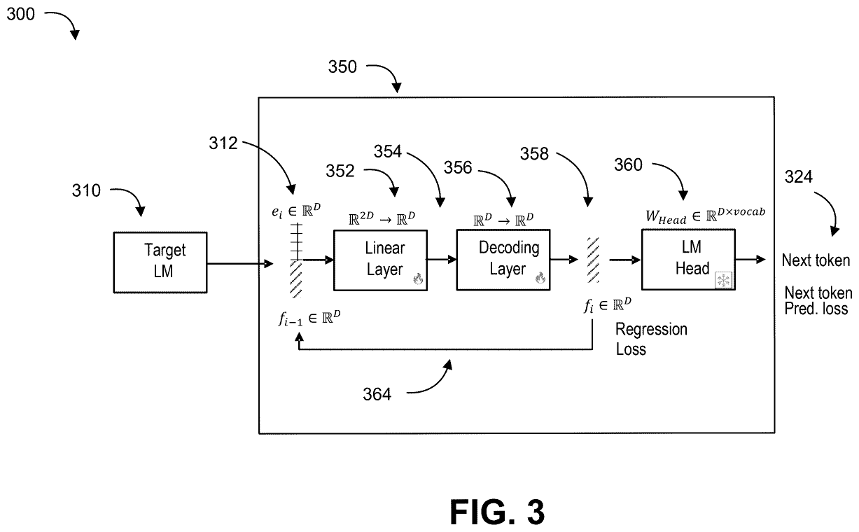

FIG. 3 is a diagram illustrating a system 300 for speculative decoding, in accordance with some aspects of the disclosure. The system 300 includes a target LLM 310 and a draft LLM 350, which may correspond to (e.g., be the same as or similar to) the target LLM 210 and the draft LLM 250, respectively, of the system 200 of FIG. 2.

As shown in FIG. 3, outputs from the target LLM 310 are provided to the draft LLM 350. For instance, as discussed above with respect to FIG. 2, various features output by the transformer layers 220 are output (e.g., as shown by pathways 240 and 242) to the draft LLM 350. The features from the transformer layers 220 are combined with (e.g., concatenated with) embeddings generated from input tokens (e.g., by the embedding layer 254) into a two-dimensional input 312 (e.g., a two-dimensional vector input). The two-dimensional input 312 is provided as input to a linear layer 352 of the draft LLM 350. The linear layer 352 and a decoding layer 356 make up an auto-regression head of the draft LLM 350 (e.g., similar to or the same as the auto-regression head 258 of the draft LLM 250 of FIG. 2).

The linear layer 352 can process the two-dimensional input 312 and generate features 354. The features 354 are provided to a decoding layer 356. As noted above, the linear layer 352 and the decoding layer 356 form the autoregression head of the draft LLM 350. An output from the decoding layer 356 includes features 358, which is a single dimensional (e.g., a one-dimensional (1D)) vector. The features 358 are output to LM head 360 (e.g., referred to as a token predictor). The LM head 360 can process the features 358 to generate a token 324.

As shown in FIG. 3, the features 358 can be fed back into the linear layer 352 in the subsequent iteration. For example, the features 358 can be combined with (e.g., concatenated with) an embedding output from an embedding layer of the draft LLM 350 (e.g., an embedding denoted as eₘₐₖₑ and/or an embedding denoted as eₕₑₗₚ from the embedding layer 254 combined with the features f₁ from the auto-regression head 258 of FIG. 2). The draft LLM 310 can be trained such that the output is as close as possible to that of the target LLM 350 (e.g., by minimizing a regression loss 364).

As discussed, some existing designs for speculative decoding (e.g., as depicted with respect to the system 200 and the system 300) may have drawbacks. For example, speculative decoding designs may not be flexible, which can make using such systems on memory-constrained devices (e.g., mobile devices) difficult. For example, a reduction in memory consumption is desired, for example, by reducing the number of parameters of draft model to enhance the speed of speculative decoding. However, in some cases, reducing the memory consumption can be difficult. For instance, the LM head can include 35%-68% of parameters of the model. Using Llama2 as an example of a target model, the number parameters is as follows (where B represents a billion):

$$AR Head ( 0.244 B ) + LM Head ( 0.13 B )$$

In another example, using Llama3 as an example of a target model, the number of parameters is as follows:

$$AR Head ( 0.244 B ) + LM Head ( 0.53 B )$$

Given that the draft model (e.g., the draft LLM) uses input from the target model (e.g., the target LLM) and uses the LM head of the target LLM, the size of the draft model cannot typically be adjusted. Accordingly, according to aspects, the systems and techniques described herein relate to improving speculative decoding systems by reducing a size of the linear layer (e.g., the linear layer 352 of FIG. 3) and the decoding layer (e.g., the decoding layer 356), which results in a performance improvement of the speculative decoding system as a whole.

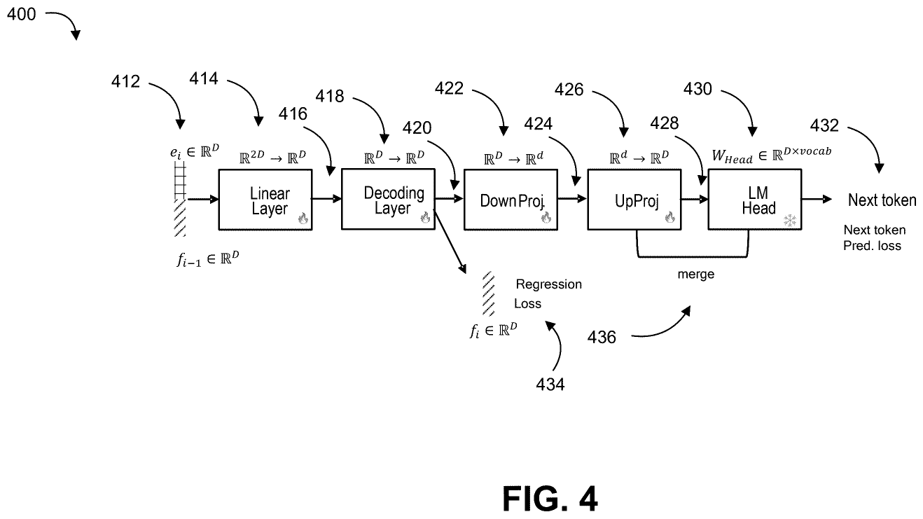

FIG. 4 is a diagram illustrating a system 400 for speculative decoding, in accordance with some aspects of the disclosure. The system 400 illustrates training of a draft LLM. During training of the draft LLM, parameters of the target model (e.g., weights, biases, etc.) are not changed (e.g., the parameters of the target model are frozen while the draft LLM is trained). As described below, the draft LLM can be trained using the system 400 by performing down projection and up projection and by generating merged projection layers, which can reduce the size of an LM head of the draft LLM.

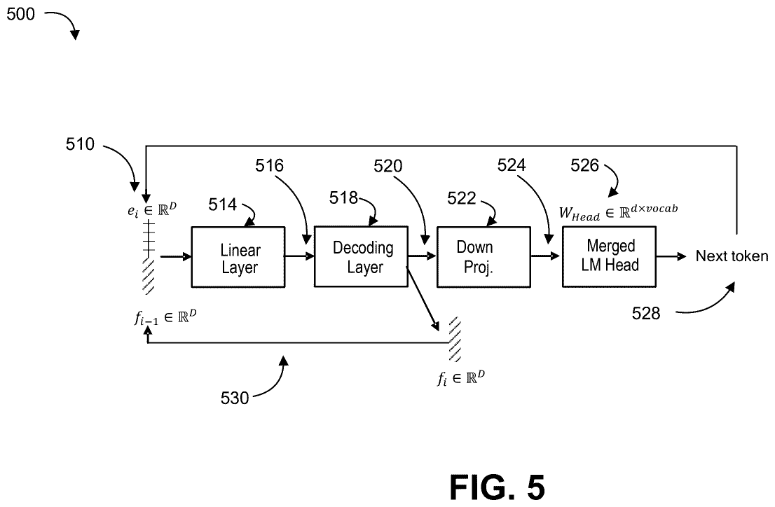

As shown, the system 400 includes a linear layer 414, a decoding layer 418, a down-projection layer 422, an up-projection layer 426, and a LM head 430. Each of linear layer 414, decoding layer 418, down-projection layer 422, and up-projection layer 426 has a corresponding set of parameters (e.g., weights, biases, etc.), which may be adjusted (e.g., tuned) during training and may be later used during inference or execution (e.g., as depicted with respect to FIG. 5). Training of the draft LLM can be an iterative flow and may be executed multiple times until such time that some criteria is met (e.g., an objective function is minimized). The parameters of LM head 430 are not generally updated during training.

As noted previously, embeddings and features can be combined (e.g., concatenated) into a two-dimensional (2D) input (e.g., a two-dimensional vector input), such as the 2D input 412 of FIG. 4. The 2D input 412 can be provided as input to the linear layer 414. The linear layer 414 can translate the 2D features of the 2D input 412 to features 416 having a dimension of D (single-dimensional features, such as a 1D vector). The linear layer 414 provides features 416 to the decoding layer 418. The decoding layer 418 processes the features 416 and outputs features 420 having dimension D (single-dimensional features, such as a 1D vector).

The down-projection layer 422 processes the features 420 and reduces a dimensionality of the features 420, resulting in output of features 424 have a reduced-dimensionality as compared to the features 420. For instance, the features 420 can have a dimension D and the features 424 can have dimension d (where d is smaller than D). Down-projection layer 422 outputs the features 424 and provides the features 424 to up-projection layer 426.

The up-projection layer 426 can process the features 424 to increase a dimensionality of the features 424. For example, the up-projection layer 426 can process the features 424, having dimension d, and can output features 428, having dimension D. The up-projection layer 426 provides the features 428 to the LM head 430. The LM head 430 can process the features 428 to generate a predicted token 432. A predicted loss (e.g., the next token prediction loss (Lₑₗₛ) described above) can then be calculated based on the predicted token 432 and an expected result (e.g., a ground truth token). Additionally, the decoding layer 418 may output the features 420 (denoted as fᵢ) to determine a regression loss 434 (e.g., the regression loss (L_{reg}) described above) between the features 420 and ground truth features. In some cases, the features 420 may be provided back to the input of the model on the subsequent iteration. Backpropagation can be performed based on prediction loss and/or the regression loss to update the parameters (e.g., weights, biases, etc.) of the linear layer 414, the decoding layer 418, the down-projection layer 422, and the up-projection layer 426. The system 400 may continue to be trained using the above-described techniques through one or more subsequent training iterations.

Up-projection layer 426 and LM head 430 are combined in a merge step 436 (e.g., after training of the system 400 is complete). In some aspects, the merge step 436 can include a matrix multiplication of the parameters (e.g., weights, biases, etc.) of the trained up-projection layer 426 (e.g., a matrix of dimensions d×D) and the parameters (e.g., weights, biases, etc.) of the trained LM head 430 (e.g., a matrix of dimensions D×vocabulary size), resulting in a merged LM head (e.g., including matrix of dimensions d×vocabulary size), such as the merged LM head 526 illustrated in and discussed below with respect to FIG. 5. The merged LM head may be used at inference with respect to the system 500 (or other system) described below with respect to FIG. 5. For example, the merged LM head may be deployed in a device that is provided to an end user.

FIG. 5 is a diagram illustrating a system 500 for speculative decoding, in accordance with some aspects of the disclosure. The system 500 illustrates the system 400 of FIG. 4 after training is completed and during inference of the draft LLM. As noted above, based on the training described with respect to FIG. 4, a reduction in a size (e.g., feature dimension) of a draft LLM is achieved based on applying down projection and up projection and by generating merged projection layers (e.g., merged LM head 526).

The system 500 includes a linear layer 514, a decoding layer 518, a down-projection layer 522, and a merged LM head 526. Each of the linear layer 514, the decoding layer 518, the down-projection layer 522, and the LM head 526 may have a corresponding set of parameters (e.g., weights, biases, etc.), which may be determined (e.g., tuned) during the training described with respect to the system 400 of FIG. 4.

To perform inference using the system 500, a 2D input 510 (e.g., resulting from combining embeddings and features) is provided to linear layer 514. The linear layer 514 can process the 2D input 510 to generate features 516, which are provided to decoding layer 518. The decoding layer 518 can process the features 516 to generate features 520. The features 520 are processed by the down-projection layer 522 to generate features 524, which are provided to the merged LM head 526 (e.g., generated based on merging of the up-projection layer 426 and the LM head 430 of the system 400 of FIG. 4). The merged LM head 526 can process the features 524 and can generate a predicted token 528. The predicted token 528 can be output and provided as an input (e.g., illustrated by feedback loop 530) into an embedding layer (e.g., the token “with” and/or the token “you” provided to embedding layer 254 of FIG. 2), which can generate an embedding of the predicted token 528. The embedding can be provided as input to the linear layer 514 in a subsequent iteration (e.g., the embedding e_{with} and/or the embedding e_{you} illustrated in FIG. 2). The features 520 can also be provided to the linear layer 514 in the subsequent iteration (e.g., the feature fₕₑₗₚ illustrated in FIG. 2).

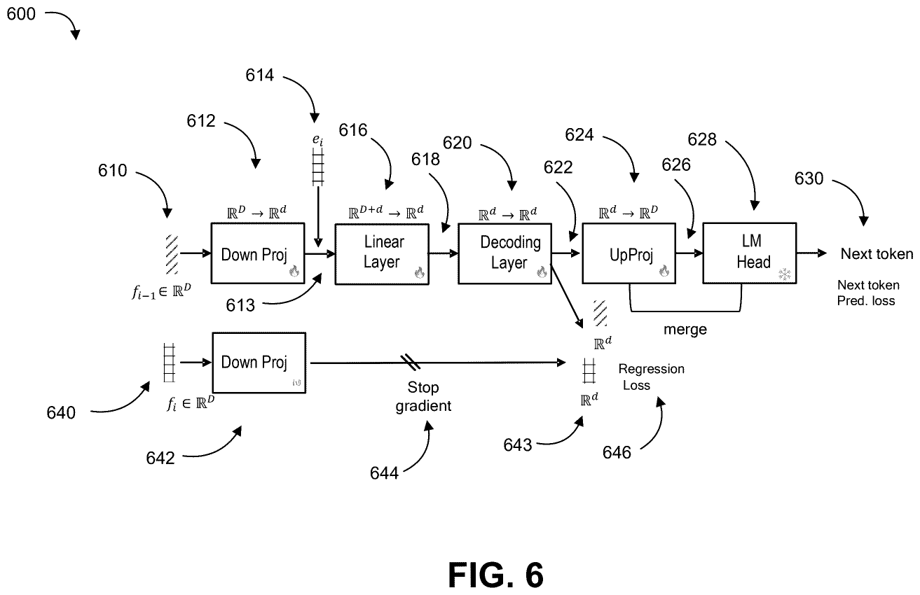

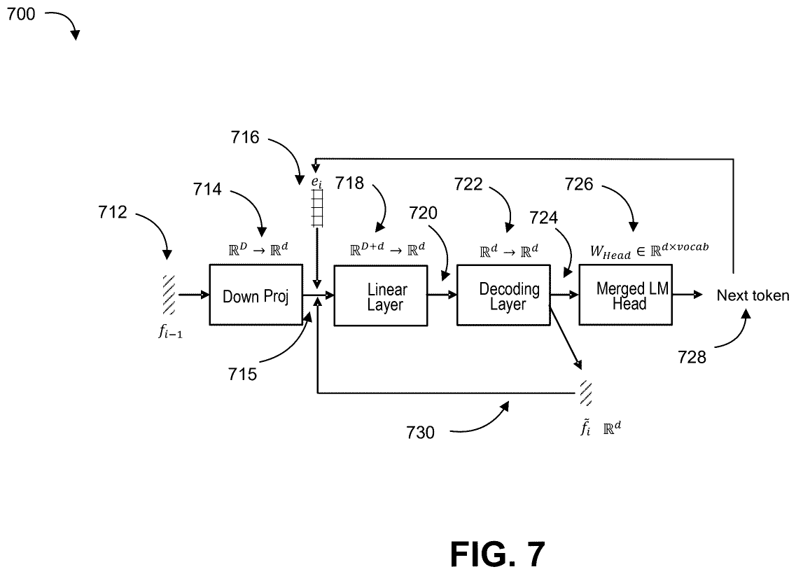

FIGS. 6 and 7 illustrate an additional improved approach to speculative decoding. Relative to the approaches depicted in FIGS. 4 and 5, the approaches depicted in FIGS. 6 and 7 maintain the reduction of in size of the LLM head and further reduce internal dimensions used for processing in the draft model by using a down-projection layer at the start of the flow. The approaches depicted in FIGS. 6 and 7 can reduce a complexity of a decoding layer of a draft model (e.g., a draft LLM) by reducing features of dimension D to features of dimension d.

In particular, FIG. 6 is a diagram illustrating a system 600 for speculative decoding, in accordance with some aspects of the disclosure. The system 700 illustrates training of a draft LLM. The system 600 includes a down-projection layer 612, a linear layer 616, a decoding layer 620, an up-projection layer 624, and a LM head 628. Each of the down-projection layer 612, the linear layer 616, the decoding layer 620, the up-projection layer 624, and the LM head 628 has a corresponding set of parameters (e.g., weights, biases, etc.), which are adjusted during training and may be later used during inference/execution of the trained draft LLM (e.g., as depicted with respect to FIG. 7).

The down-projection layer 612 can lower dimensions of input features 610 for processing by the linear layer 616. For instance, the down-projection layer 612 can receive features 610, of dimension D, and can reduce the dimension of the features 610 to features 613 having a dimension d (illustrated as R^{D}→R^{d}). The input features 610 can be generated in a prior iteration (e.g., iteration i−1) of the training process. The generated features 613 can be combined with (e.g., concatenated) with embeddings 614 to generate a 2D input. The embeddings 614 be received from an embedding layer (e.g., the embedding layer 254 of FIG. 2) of the draft LLM in the current iteration (e.g., iteration i) of the training process. The combination of the features 613 and the embeddings 614 results in the 2D input features of dimensions D+d. The 2D input can be provided as input to the linear layer 616.

The linear layer 616 can process the 2D input to generate features 618 of dimension d. The features 618 can be output to the decoding layer 620 for processing. The decoding layer 620 can process the features 618 to generate features 622 having dimension d, which are output to the up-projection layer 624. The up-projection layer 624 can process the features 622 and can output features 626 having dimension D. The LM head 628 can process the features 626 to generate a predicted token 630. Similar to that described with respect to FIG. 4, the up-projection layer 624 and the LM head 628 can be merged to generate a merged LM head (e.g., the merged LM head 726 of FIG. 7).

In some cases, due to a mismatch in feature sizes between training feature sizes and the draft model's feature dimension d, a parallel flow may occur that includes a down-projection layer 642, a stop gradient 644, and a regression loss 646. The down-projection layer 642 can perform down-projection of target features 640 (denoted as f(i)) to generate downscaled features 643 (denoted as R^{D}). The target features 640 are of dimension D and can be ground truth features (e.g., received from a target model, such as a target LLM). A regression loss 646 can be determined by comparing the downscaled features 643 to the features 622 output by the decoding layer 620. The stop gradient 644 can prevent gradients from flowing into the regression loss 646. Without the stop gradient 644, the draft model may determine or locate shortcuts to minimize the loss, which can result in a trivial solution that does not perform well. In some cases, the stop gradient 644 can be implemented by detaching an output of the additional down-projection layer 642 from a computation graph.

FIG. 7 is a diagram illustrating a system 700 for speculative decoding, in accordance with some aspects of the disclosure. The system 700 illustrates the system 600 of FIG. 6 after training is completed and during inference of the draft LLM. As discussed below, system 700 may reduce the internal dimensions used in the draft model, thereby improving performance.

The system 700 includes a down-projection layer 714, a linear layer 718, a decoding layer 722, and an LM head 726. Each of the down-projection layer 714, the linear layer 718, the decoding layer 722, and the LM head 726 has a corresponding set of parameters (e.g., weights, biases, etc.), which may be determined (e.g., tuned) during the training described with respect to the system 600 of FIG. 6.

To perform inference using the system 700, the down-projection layer 714 can process features 712, which have dimensions D. Based on processing the features 712, the down-projection layer 714 can generate and output features 715 of dimensions d. The features 715 and embeddings 716 (e.g., from an embedding layer of the draft model) can be combined (e.g., concatenated), resulting in a 2D input (e.g., a 2D vector) having dimensions D+d. The 2D input can be provided to the linear layer 718 for processing.

The linear layer 718 can process the 2D input to generate features 720 of dimensions d (e.g., a single-dimensional vector, such as a 1D vector). The linear layer 718 can output the features 720 for processing by the decoding layer 722. The decoding layer 722 can process the features 720 to generate features 724, having dimensions d, and can output he features 724 to the merged LM head 726. The merged LM head 726 can process the features 724 to generate a predicted token 728. As shown, the merged LM head includes parameters of dimension d×vocabulary size (denoted as W_{HEAD}∈ [symbol] ^{d×vocab}). The predicted token 728 can be output and provided as an input (e.g., illustrated by feedback loop 730) into an embedding layer (e.g., the token “make” and/or the token “help” provided to embedding layer 254 of FIG. 2), which can generate an embedding of the predicted token 728. The embedding can be provided as input to the linear layer 718 in a subsequent iteration (e.g., the embedding eₘₐₖₑ and/or the embedding @help illustrated in FIG. 2). The features 724 can also be provided to the linear layer 718 in the subsequent iteration (e.g., the feature f₁ illustrated in FIG. 2).

An evaluation of disclosed aspects can be performed using one or more datasets, such as the “MT-Bench (Multi-turn Chat)” and “Dolly15k (Creative Writing)” datasets. Various metrics can be examined, including block efficiency and memory bound speed up. Block Efficiency is measured by an average number of tokens generated per target model call:

$$Block Efficiency = ( Number of accepted tokens ) + 1$$

Memory bound speed up is a metric that represents an increase in speed of the systems and techniques described herein solutions as compared to the target LM inference. The metric assumes that each model's runtime is proportional to the model size

$$MBSU = \frac{Block Efficiency}{tree\_depth * \frac{{N}_{draft}}{{N}_{target}} + 1}$$

Experimental results supported the proposition that reducing the parameters of LM head can enhance the LLM acceleration. For example, the merged LM head does not degrade block efficiency and provides a potential of further developing the LM Head. The auto-regression model may also be improved using the disclosed techniques.

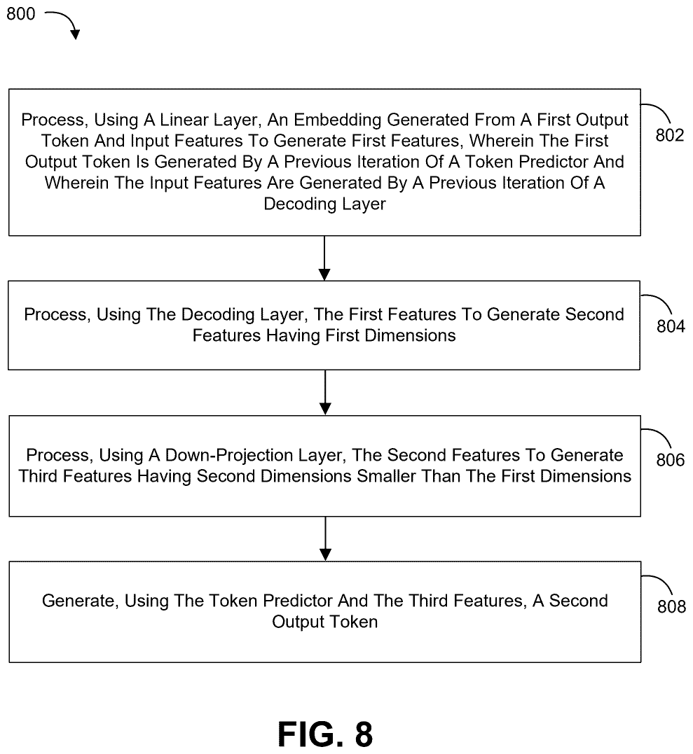

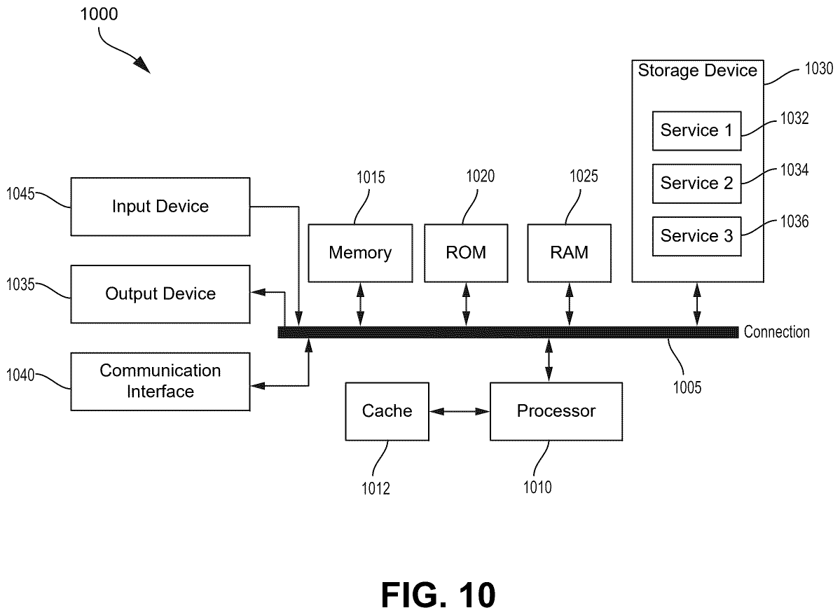

FIG. 8 is a flow diagram illustrating another example of process for speculative decoding, in accordance with some aspects of the disclosure. The process 800 can be performed by a computing device (e.g., a computing device or computing system 1000 of FIG. 10) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 800 may be implemented as software components that are executed and run on one or more processors (e.g., processor 1010 of FIG. 10, or other processor(s)). Further, the transmission and reception of signals by the computing device in the process 800 may be enabled, for example, by one or more antennas and/or one or more transceivers (e.g., wireless transceiver(s)).

At block 802, the computing device (or component thereof) can process, using a linear layer (e.g., the linear layer 414 of the system 400 of FIG. 4, the linear layer 514 of the system 500 of FIG. 5, or other down-projection layer) of a machine learning model, an embedding (e.g., the embedding e; input to the linear layer 414 of FIG. 4, the embedding e; input to the linear layer 514 of FIG. 5, etc.) generated from a first output token and input features (e.g., the features fᵢ₋₁ input to the linear layer 414 of FIG. 4, the features fᵢ₋₁ input to the linear layer 514 of FIG. 5, etc.) to generate first features (e.g., the features 416 of FIG. 4, the features 516 of FIG. 5, etc.). For instance, as described with respect to FIG. 5, the linear layer 514 of FIG. 5 can translate the 2D features of the 2D input 512 (including the embedding e; and the features fᵢ₋₁) to features 516 having a dimension of D (single-dimensional features, such as a 1D vector). In some cases, the machine learning model can include a transformer-based draft model, such as a draft LLM. The first output token is generated by a previous iteration of a token predictor (e.g., the merged LM head 526 of the system 500 of FIG. 5) and the input features (e.g., the features fᵢ₋₁) are generated by a previous iteration of a decoding layer (e.g., the decoding layer 418 of the system 400 of FIG. 4, the decoding layer 518 of the system 500 of FIG. 5, etc.).

In some aspects, the linear layer includes first parameters, the decoding layer includes second parameters, and the down-projection layer includes third parameters. In some cases, the first parameters, the second parameters, and the third parameters are determined based on training the machine learning model (e.g., as described with respect to FIG. 4). For instance, the training can include processing, using the linear layer, a training embedding of a first training token and a training input token to generate first training features. The training can further include processing, using the decoding layer, the first training features to generate second training features. The training can further include processing, using the down-projection layer, the second training features to generate third training features. The training can further include processing, using an up-projection layer, the third training features to generate fourth training features and generating, using the token predictor and the fourth training features, an additional training token. In some cases, a regression loss can be determined based on the second training features and ground truth features. In such cases, the first parameters, the second parameters, and the third parameters are determined based on the regression loss.

At block 804, the computing device can process, using the decoding layer, the first features to generate second features (e.g., the features 420 shown in FIG. 4, the features 520 shown in FIG. 5, etc.) having first dimensions.

At block 806, the computing device can process, using a down-projection layer (e.g., the down-projection layer 422 of the system 400 of FIG. 4, the down-projection layer 522 of the system 500 of FIG. 5, or other down-projection layer), the second features to generate third features (e.g., the features 424 shown in FIG. 4, the features 524 shown in FIG. 5, etc.) having second dimensions smaller than the first dimensions.

At block 808, the computing device can generate, using the token predictor (e.g., the merged LM head 526 of the system 500 of FIG. 5) and the third features (e.g., the features 524 shown in FIG. 5, etc.), a second output token (e.g., the next predicted token 528 of FIG. 5). In some aspects, parameters of the token predictor are generated based on merging the up-projection layer with the token predictor.

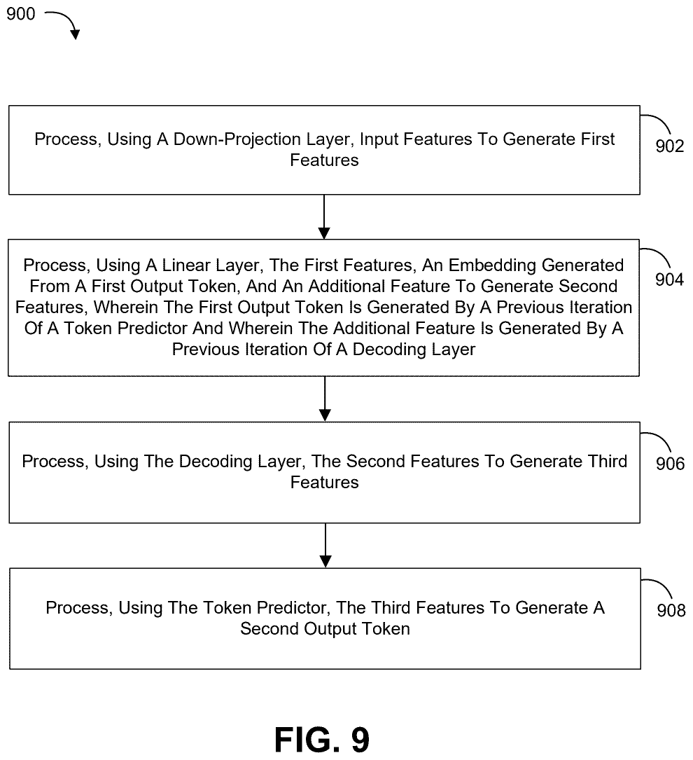

FIG. 9 is a flow diagram illustrating another example of process for speculative decoding, in accordance with some aspects of the disclosure. The process 900 can be performed by a computing device (e.g., a computing device or computing system 1000 of FIG. 10) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 900 may be implemented as software components that are executed and run on one or more processors (e.g., processor 1010 of FIG. 10, or other processor(s)). Further, the transmission and reception of signals by the computing device in the process 900 may be enabled, for example, by one or more antennas and/or one or more transceivers (e.g., wireless transceiver(s)).

At block 902, the computing device (or component thereof) can process, using a down-projection layer (e.g., the down-projection layer 612 of the system 600 of FIG. 6, the down-projection layer 714 of the system 700 of FIG. 7, or other down-projection layer) of a machine learning model, input features (e.g., the features fᵢ₋₁ input to the down-projection layer 612 of the system 600 of FIG. 6, the features fᵢ₋₁ input to the down-projection layer 712 of the system 700 of FIG. 7, etc.) to generate first features (e.g., the features 613 of FIG. 6, the features 715 of FIG. 7, etc.). In some cases, the machine learning model can include a transformer-based draft model, such as a draft LLM. In some aspects, the input features (e.g., the features fᵢ₋₁) are generated from a previous iteration of a decoding layer (e.g., the decoding layer 620 of the system 600 of FIG. 6, the decoding layer 722 of the system 700 of FIG. 7, etc.). In some cases, the down-projection layer includes first parameters, the linear layer includes second parameters, and the decoding layer includes third parameters. In some examples, the first parameters, the second parameters, and the third parameters are determined based on training the machine learning model (e.g., as described with respect to FIG. 6). For instance, the training can include processing, using the down-projection layer, training input features to generate first training features. The training can further include processing, using the linear layer, the first training features and a training embedding generated from a first training token to generate second training features. The training can further include processing, using the decoding layer, the second training features to generate third training features. The training can further include processing, using an up-projection layer, the third training features to generate fourth training features. The training can further include processing, using the token predictor, the fourth training features to generate a training output token. In some aspects, the computing device (or component thereof) can process, using the down-projection layer and a stop gradient, a target feature to generate an updated regression loss, which can be used to train the machine learning model.

At block 904, the computing device (or component thereof) can process, using a linear layer (e.g., the linear layer 614 of the system 600 of FIG. 6, the down-projection layer 714 of the system 700 of FIG. 7, or other down-projection layer), the first features (e.g., the features 613 of FIG. 6, the features 715 of FIG. 7, etc.), an embedding generated from a first output token (e.g., the embedding 614 generated from the output token 630 of FIG. 6, the embedding 716 generated from the output token 728 of FIG. 7, etc.), and an additional feature to generate second features (e.g., the features 618 of FIG. 6, the features 720 of FIG. 7, etc.). The first output token is generated by a previous iteration of a token predictor (e.g., the merged LM head 726 of FIG. 7) and the additional feature is generated by a previous iteration of a decoding layer.

At block 906, the computing device (or component thereof) can process, using the decoding layer, the second features (e.g., the features 622 of FIG. 6, the features 724 of FIG. 7, etc.) to generate third features.

At block 908, the computing device (or component thereof) can process, using the token predictor (e.g., the merged LM head 726 of FIG. 7), the third features to generate a second output token (e.g., the next output token 728 of FIG. 7).

In some cases, the computing device of processes 800 and/or 900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 800 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 800 and 900 are illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 800 and/or 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some examples, the processes described herein (e.g., processes 800, 900, and/or other process described herein) may be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device.

FIG. 10 is a block diagram illustrating an example of a computing system 1000, which may be employed for hybrid forward-backward model training with cross momentums for an edge neural processor. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random-access memory (RAM) 1025 to processor 1010. Computing system 1000 can include a cache 1012 of high-speed memory connected directly with, in close proximity to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

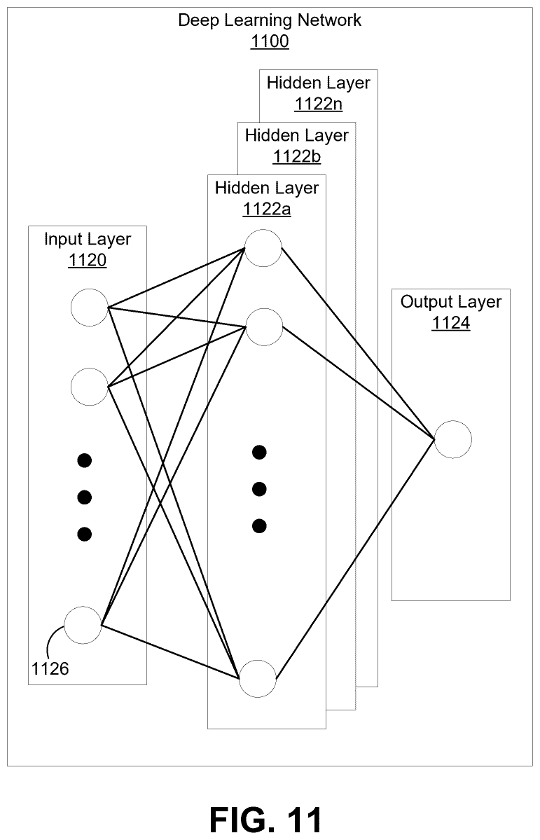

FIG. 11 is an illustrative example of a deep learning neural network 1100 that can be used by the machine learning model. An input layer 1120 includes input data. In some examples, the input layer 1120 can include data representing the pixels of an input video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1124 that provides an output resulting from the processing performed by the hidden layers 1122a, 1122b, through 1122n. In some examples, the output layer 1124 can provide a classification for an object in an input video frame. The classification can include a class identifying the type of object (e.g., a person, a dog, a cat, or other object).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the hidden layers 1122a, 1122b, through 1122n can transform the information of each input node by applying activation functions to the information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1124, at which an output is provided. In some cases, while nodes (e.g., node 1126) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1122n in order to provide the output through the output layer 1124. In an example in which the neural network 1100 is used to identify objects in images, the neural network 1100 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 1100 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1100 is trained well enough so that the weights of the layers are accurately tuned.

For the example of identifying objects in images, the forward pass can include passing a training image through the neural network 1100. The weights are initially randomized before the neural network 1100 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1100 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 1100 can include any suitable deep network. As described previously, an example of a neural network 1100 includes a convolutional neural network (CNN), which includes an input layer and an output layer, with multiple hidden layers between the input and out layers. An example of a CNN is described below with respect to FIG. 3. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

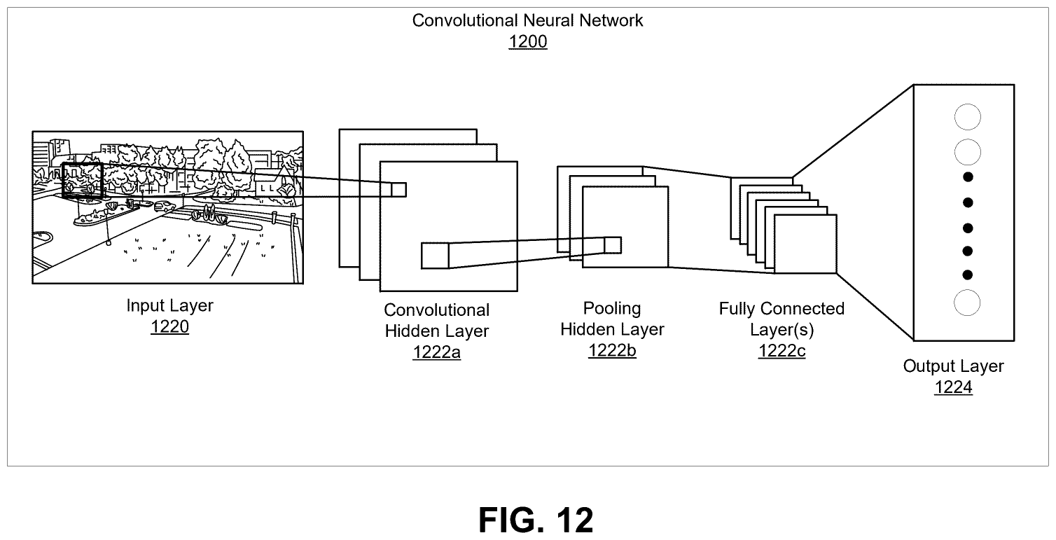

FIG. 12 is an illustrative example of a convolutional neural network 1200 (CNN 1200). The input layer 1220 of the CNN 1200 includes data representing an image. For example, the data can include an array of numbers representing the pixels of the image, with each number in the array including a value from 0 to 255 describing the pixel intensity at that position in the array. Using the previous example from above, the array can include a 28×28×12 array of numbers with 28 rows and 28 columns of pixels and 12 color components (e.g., red, green, and blue, or luma and two chroma components, or the like). The image can be passed through a convolutional hidden layer 1222a, an optional non-linear activation layer, a pooling hidden layer 1222b, and fully connected hidden layers 1222c to get an output at the output layer 1224. While only one of each hidden layer is shown in FIG. 12, one of ordinary skill will appreciate that multiple convolutional hidden layers, non-linear layers, pooling hidden layers, and/or fully connected layers can be included in the CNN 1200. As previously described, the output can indicate a single class of an object or can include a probability of classes that best describe the object in the image.

The first layer of the CNN 1200 is the convolutional hidden layer 1222a. The convolutional hidden layer 1222a analyzes the image data of the input layer 1220. Each node of the convolutional hidden layer 1222a is connected to a region of nodes (pixels) of the input image called a receptive field. The convolutional hidden layer 1222a can be considered as one or more filters (each filter corresponding to a different activation or feature map), with each convolutional iteration of a filter being a node or neuron of the convolutional hidden layer 1222a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 1222a. Each connection between a node and a receptive field for that node learns a weight and, in some cases, an overall bias such that each node learns to analyze its particular local receptive field in the input image. Each node of the hidden layer 1222a will have the same weights and bias (called a shared weight and a shared bias). For example, the filter has an array of weights (numbers) and the same depth as the input. A filter will have a depth of 12 for the video frame example (according to three color components of the input image). An illustrative example size of the filter array is 5×5×12, corresponding to a size of the receptive field of a node.

The convolutional nature of the convolutional hidden layer 1222a is due to each node of the convolutional layer being applied to its corresponding receptive field. For example, a filter of the convolutional hidden layer 1222a can begin in the top-left corner of the input image array and can convolve around the input image. As noted above, each convolutional iteration of the filter can be considered a node or neuron of the convolutional hidden layer 1222a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1222a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1222a.

The mapping from the input layer to the convolutional hidden layer 1222a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1222a can include several activation maps in order to identify multiple features in an image. The example shown in FIG. 12 includes three activation maps. Using three activation maps, the convolutional hidden layer 1222a can detect three different kinds of features, with each feature being detectable across the entire image.

In some examples, a non-linear hidden layer can be applied after the convolutional hidden layer 1222a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1200 without affecting the receptive fields of the convolutional hidden layer 1222a.

The pooling hidden layer 1222b can be applied after the convolutional hidden layer 1222a (and after the non-linear hidden layer when used). The pooling hidden layer 1222b is used to simplify the information in the output from the convolutional hidden layer 1222a. For example, the pooling hidden layer 1222b can take each activation map output from the convolutional hidden layer 1222a and generates a condensed activation map (or feature map) using a pooling function. Max-pooling is an example of a function performed by a pooling hidden layer. Other forms of pooling functions be used by the pooling hidden layer 1222a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1222a. In the example shown in FIG. 12, three pooling filters are used for the three activation maps in the convolutional hidden layer 1222a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1222a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1222a having a dimension of 24×24 nodes, the output from the pooling hidden layer 1222b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. The positional information can be discarded can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1200.

The final layer of connections in the network is a fully connected layer that connects every node from the pooling hidden layer 1222b to every one of the output nodes in the output layer 1224. Using the example above, the input layer includes 28×28 nodes encoding the pixel intensities of the input image, the convolutional hidden layer 1222a includes 12×24×24 hidden feature nodes based on application of a 5×5 local receptive field (for the filters) to three activation maps, and the pooling layer 1222b includes a layer of 12×12×12 hidden feature nodes based on application of max-pooling filter to 2×2 regions across each of the three feature maps. Extending the above example, the output layer 1224 can include ten output nodes. In such an example, every node of the 12×12×12 pooling hidden layer 1222b is connected to every node of the output layer 1224.

The fully connected layer 1222c can obtain the output of the previous pooling layer 1222b (which should represent the activation maps of high-level features) and determines the features that most correlate to a particular class. For example, the fully connected layer 1222c layer can determine the high-level features that most strongly correlate to a particular class and can include weights (nodes) for the high-level features. A product can be computed between the weights of the fully connected layer 1222c and the pooling hidden layer 1222b to obtain probabilities for the different classes. For example, if the CNN 1200 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1224 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 00.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

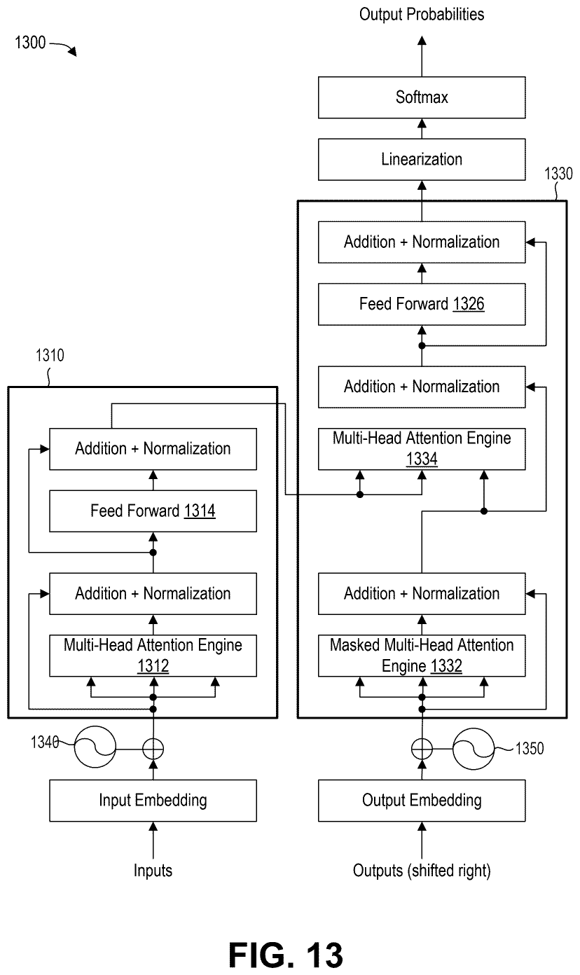

FIG. 13 is a block diagram of an example transformer. In a convolutional neural network (CNN) model, the number of operations required to relate signals from two arbitrary input or output positions grows in the distance between positions, which makes learning dependencies at different distant positions challenging for a CNN model. A transformer 1300 reduces the operations of learning dependencies by using an encoder 1310 and a decoder 1330 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1310 is composed of a stack of six identical layers and each layer has two sub-layers. The first sub-layer is a multi-head self-attention engine 1312, and the second sub-layer is a fully connected feed-forward network 1314. A residual connection (not shown) connects around each of the sub-layers followed by normalization.

In the example transformer 1300, the decoder 1330 is also composed of a stack of six (6) identical layers. The decoder also includes a masked multi-head self-attention engine 1332, a multi-head attention engine 1334 over the output of the encoder 1310, and a fully connected feed-forward network 1326. Each layer includes a residual connection (not shown) around the layer, which is followed by layer normalization. The masked multi-head self-attention engine 1332 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1340 to encode positions because the model does not contain recurrence and convolution, and relative or absolute position of the tokens is needed. In the transformer 1300, the positional encodings are added to the input embeddings at the bottom layer of the encoder 1310 and the decoder 1330. The positional encodings are summed with the embeddings because the positional encodings and embeddings have the same dimensions. A corresponding position decoder 1350 is configured to decode the positions of the embeddings for the decoder 1330.

In some aspects, the transformer 1300 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1300 can process input sequences of variable length, making the transformer 1300 well-suited for natural language processing tasks where input lengths can vary greatly. Additionally, the self-attention mechanism allows the transformer 1300 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

As previously mentioned, semantic segmentation is a computer vision task that assigns a class label to pixels within an image by using a machine learning algorithm. Semantic segmentation tasks assist machines to distinguish between different object classes and background regions within an image. Semantic segmentation of images (along with the creation of semantic maps) is used to train computers to recognize important context in digital images, such as landscapes, people, medical images, and more.

As noted above, open-vocabulary semantic segmentation performs semantic segmentation with unknown classes. Open-vocabulary semantic segmentation aims to segment an image into semantic regions according to textual descriptions (e.g., unknown classes), which may have not been seen during training of the machine learning algorithm. Two-stage methods (e.g., side adaptor network (SAN), open-vocabulary diffusion-based panoptic segmentation (ODISE), and panoptic open-vocabular segment anything model (PosSAM)) have been recently used that first generate class-agnostic mask proposals and, then, leverage pre-trained vision foundation models (e.g., contrastive language-image pre-training (CLIP) model, stable diffusion, and the segment anything model (SAM)) to classify masked regions (e.g., for the open-vocabulary semantic segmentation task). These open-vocabulary semantic segmentation models (e.g., SAN and ODISE) have been adapted to understand a user's personal expressions (e.g., “my cup”), not just generic terms (e.g., “cup”)

Large-scale vision-language models (e.g., CLIP) have led to improvements in open-vocabulary semantic segmentation. Unlike traditional semantic segmentation that is limited to making segmentation predictions within a fixed set of categories, open-vocabulary semantic segmentation enables the segmentation of regions with arbitrary classes that are not used during the training phase. Such models are crucial for deploying semantic segmentation models in real-world applications since novel categories may be encountered that were not seen during the training of the models. Despite previous studies in open-vocabulary semantic segmentation, segmenting a region that a user is interested in using unseen categories has been underexplored. For example, finding “my favorite cup” among a number of cups can be challenging for existing open-vocabulary semantic segmentation methods that often produce false positive predictions. Although there exists another group of methods which focuses on few-shot semantic segmentation. These methods are designed for only a closed-set semantic segmentation, which can limit their applicability in the real world.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding or incorporated in a combined video encoder-decoder (CODEC).

Illustrative aspects of the disclosure include:

Aspect 1. A method of using a machine learning model to generate tokens, the method comprising: processing, using a linear layer, an embedding generated from a first output token and input features to generate first features, wherein the first output token is generated by a previous iteration of a token predictor and wherein the input features are generated by a previous iteration of a decoding layer; processing, using the decoding layer, the first features to generate second features having first dimensions; processing, using a down-projection layer, the second features to generate third features having second dimensions smaller than the first dimensions; and generating, using the token predictor and the third features, a second output token.

Aspect 2. The method of aspect 1, wherein the linear layer comprises first parameters, the decoding layer comprises second parameters, and the down-projection layer comprises third parameters.

Aspect 3. The method of aspect 2, wherein the first parameters, the second parameters, and the third parameters are determined based on training the machine learning model, wherein the training comprises: processing, using the linear layer, a training embedding of a first training token and a training input token to generate first training features; processing, using the decoding layer, the first training features to generate second training features; processing, using the down-projection layer, the second training features to generate third training features; processing, using an up-projection layer, the third training features to generate fourth training features; and generating, using the token predictor and the fourth training features, an additional training token.

Aspect 4. The method of aspect 3, further comprising determining a regression loss based on the second training features and ground truth features, wherein the first parameters, the second parameters, and the third parameters are determined based on the regression loss.

Aspect 5. The method of aspects 1-4, wherein parameters of the token predictor are generated based on merging the up-projection layer with the token predictor.

Aspect 6. The method of aspects 1-5, wherein the machine learning model is a large language model (LLM).

Aspect 7. A method of using a machine learning model to generate tokens, the method comprising: processing, using a down-projection layer, input features to generate first features; processing, using a linear layer, the first features, an embedding generated from a first output token, and an additional feature to generate second features, wherein the first output token is generated by a previous iteration of a token predictor and wherein the additional feature is generated by a previous iteration of a decoding layer; processing, using the decoding layer, the second features to generate third features; and processing, using the token predictor, the third features to generate a second output token.

Aspect 8. The method of aspect 7, wherein the down-projection layer comprises first parameters, the linear layer comprises second parameters, and the decoding layer comprises third parameters.

Aspect 9. The method of aspect 8, wherein the first parameters, the second parameters, and the third parameters are determined based on training the machine learning model, wherein the training comprises: processing, using the down-projection layer, training input features to generate first training features; processing, using the linear layer, the first training features and a training embedding generated from a first training token to generate second training features; processing, using the decoding layer, the second training features to generate third training features; processing, using an up-projection layer, the third training features to generate fourth training features; and processing, using the token predictor, the fourth training features to generate a training output token.

Aspect 10. The method of aspect 9, further comprising processing, using the down-projection layer and a stop gradient, a target feature to generate an updated regression loss.

Aspect 11. The method of aspects 7-10, wherein the input features are generated from a previous iteration of the decoding layer.

Aspect 12. The method of aspect 7-10, wherein the machine learning model is a large language model (LLM).

Aspect 13. An apparatus for using a machine learning model to generate tokens, the apparatus comprising: at least one memory; and at least one processor coupled to the at least one memory and configured to: process, using a linear layer, an embedding generated from a first output token and input features to generate first features, wherein the first output token is generated by a previous iteration of a token predictor and wherein the input features are generated by a previous iteration of a decoding layer; process, using the decoding layer, the first features to generate second features having first dimensions; process, using a down-projection layer, the second features to generate third features having second dimensions smaller than the first dimensions; and generate, using the token predictor and the third features, a second output token.

Aspect 14. The apparatus of aspect 13, wherein the linear layer comprises first parameters, the decoding layer comprises second parameters, and the down-projection layer comprises third parameters.

Aspect 15. The apparatus of aspects 13-14, wherein the first parameters, the second parameters, and the third parameters are determined based on training the machine learning model, wherein the training comprises: processing, using the linear layer, a training embedding of a first training token and a training input token to generate first training features; processing, using the decoding layer, the first training features to generate second training features; processing, using the down-projection layer, the second training features to generate third training features; processing, using an up-projection layer, the third training features to generate fourth training features; and generating, using the token predictor and the fourth training features, an additional training token.

Aspect 16. The apparatus of aspect 13-15, wherein the at least one processor is configured to: determine a regression loss based on the second training features and ground truth features, wherein the first parameters, the second parameters, and the third parameters are determined based on the regression loss.

Aspect 17. The apparatus of aspects 15-16, wherein parameters of the token predictor are generated based on merging the up-projection layer with the token predictor.

Aspect 18. The apparatus of aspects 13-16, wherein the machine learning model is a large language model (LLM).

Aspect 19. An apparatus for using a machine learning model to generate tokens, the apparatus comprising: at least one memory; and at least one processor coupled to the at least one memory and configured to: process, using a down-projection layer, input features to generate first features; process, using a linear layer, the first features, an embedding generated from a first output token, and an additional feature to generate second features, wherein the first output token is generated by a previous iteration of a token predictor and wherein the additional feature is generated by a previous iteration of a decoding layer; process, using the decoding layer, the second features to generate third features; and process, using the token predictor, the third features to generate a second output token.

Aspect 20. The apparatus of aspect 19, wherein the down-projection layer comprises first parameters, the linear layer comprises second parameters, and the decoding layer comprises third parameters.

Aspect 21. The apparatus of aspect 20, wherein the first parameters, the second parameters, and the third parameters are determined based on training the machine learning model, wherein the training comprises: processing, using the down-projection layer, training input features to generate first training features; processing, using the linear layer, the first training features and a training embedding generated from a first training token to generate second training features; processing, using the decoding layer, the second training features to generate third training features; processing, using an up-projection layer, the third training features to generate fourth training features; and processing, using the token predictor, the fourth training features to generate a training output token.

Aspect 22. The apparatus of aspects 19-21, wherein the at least one processor is configured to process, using the down-projection layer and a stop gradient, a target feature to generate an updated regression loss.

Aspect 23. The apparatus of aspects 19-22, wherein the input features are generated from a previous iteration of the decoding layer.

Aspect 24. The apparatus of aspects 19-23, wherein the machine learning model is a large language model (LLM).

Aspect 25. A non-transitory computer-readable medium having stored thereon instructions that, when executed by at least one processor, cause the at least one processor to perform operations according to any of Aspects 1-6.

Aspect 26. An apparatus for using a machine learning model to generate tokens, the apparatus including one or more means for performing operations according to any of Aspects 1-6.

Aspect 25. A non-transitory computer-readable medium having stored thereon instructions that, when executed by at least one processor, cause the at least one processor to perform operations according to any of Aspects 7-12.

Aspect 26. An apparatus for using a machine learning model to generate tokens, the apparatus including one or more means for performing operations according to any of Aspects 7-12.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for using a machine learning model to generate tokens, the apparatus comprising:
at least one memory; and
at least one processor coupled to the at least one memory and configured to:
process, using a down-projection layer, input features to generate first features;
process, using a linear layer, the first features, an embedding generated from a first output token, and an additional feature to generate second features, wherein the first output token is generated by a previous iteration of a token predictor and wherein the additional feature is generated by a previous iteration of a decoding layer;
process, using the decoding layer, the second features to generate third features; and
process, using the token predictor, the third features to generate a second output token.

2. The apparatus of claim 1, wherein the down-projection layer comprises first parameters, the linear layer comprises second parameters, and the decoding layer comprises third parameters.

3. The apparatus of claim 2, wherein the first parameters, the second parameters, and the third parameters are determined based on training the machine learning model, wherein the training comprises:
processing, using the down-projection layer, training input features to generate first training features;
processing, using the linear layer, the first training features and a training embedding generated from a first training token to generate second training features;
processing, using the decoding layer, the second training features to generate third training features;
processing, using an up-projection layer, the third training features to generate fourth training features; and
processing, using the token predictor, the fourth training features to generate a training output token.

4. The apparatus of claim 3, wherein the at least one processor is configured to process, using the down-projection layer and a stop gradient, a target feature to generate an updated regression loss.

5. The apparatus of claim 3, wherein parameters of the token predictor are generated based on merging the up-projection layer with the token predictor.

6. The apparatus of claim 1, wherein the input features are generated from a previous iteration of the decoding layer.

7. The apparatus of claim 1, wherein the machine learning model is a large language model (LLM).

8. A method of using a machine learning model to generate tokens, the method comprising:
processing, using a down-projection layer, input features to generate first features;
processing, using a linear layer, the first features, an embedding generated from a first output token, and an additional feature to generate second features, wherein the first output token is generated by a previous iteration of a token predictor and wherein the additional feature is generated by a previous iteration of a decoding layer;
processing, using the decoding layer, the second features to generate third features; and
processing, using the token predictor, the third features to generate a second output token.

9. The method of claim 8, wherein the down-projection layer comprises first parameters, the linear layer comprises second parameters, and the decoding layer comprises third parameters.

10. The method of claim 9, wherein the first parameters, the second parameters, and the third parameters are determined based on training the machine learning model, wherein the training comprises:
processing, using the down-projection layer, training input features to generate first training features;
processing, using the linear layer, the first training features and a training embedding generated from a first training token to generate second training features;
processing, using the decoding layer, the second training features to generate third training features;
processing, using an up-projection layer, the third training features to generate fourth training features; and
processing, using the token predictor, the fourth training features to generate a training output token.

11. The method of claim 10, further comprising processing, using the down-projection layer and a stop gradient, a target feature to generate an updated regression loss.

12. The method of claim 10, wherein parameters of the token predictor are generated based on merging the up-projection layer with the token predictor.

13. The method of claim 8, wherein the input features are generated from a previous iteration of the decoding layer.

14. The method of claim 8, wherein the machine learning model is a large language model (LLM).

15. A non-transitory computer-readable medium having stored thereon instructions that, when executed by at least one processor, cause the at least one processor to:
process, using a down-projection layer of a machine learning model, input features to generate first features;
process, using a linear layer, the first features, an embedding generated from a first output token, and an additional feature to generate second features, wherein the first output token is generated by a previous iteration of a token predictor and wherein the additional feature is generated by a previous iteration of a decoding layer;
process, using the decoding layer, the second features to generate third features; and
process, using the token predictor, the third features to generate a second output token.

16. The non-transitory computer-readable medium of claim 15, wherein the down-projection layer comprises first parameters, the linear layer comprises second parameters, and the decoding layer comprises third parameters.

17. The non-transitory computer-readable medium of claim 16, wherein the first parameters, the second parameters, and the third parameters are determined based on training the machine learning model, wherein the training comprises:
processing, using the down-projection layer, training input features to generate first training features;
processing, using the linear layer, the first training features and a training embedding generated from a first training token to generate second training features;
processing, using the decoding layer, the second training features to generate third training features;
processing, using an up-projection layer, the third training features to generate fourth training features; and
processing, using the token predictor, the fourth training features to generate a training output token.

18. The non-transitory computer-readable medium of claim 17, wherein the instructions, when executed by the at least one processor, cause the at least one processor to process, using the down-projection layer and a stop gradient, a target feature to generate an updated regression loss.

19. The non-transitory computer-readable medium of claim 17, wherein parameters of the token predictor are generated based on merging the up-projection layer with the token predictor.

20. The non-transitory computer-readable medium of claim 15, wherein the input features are generated from a previous iteration of the decoding layer.
